(19) United States
(12) Patent Application Publication
(10) Pub. No.: US 2015/0307781 A1
(43) Pub. Date: Oct. 29, 2015

(54) LIQUID CRYSTAL ALIGNMENT AGENT AND USES THEREOF

(71) Applicant: CHI MEI CORPORATION, TAINAN CITY (TW)

(72) Inventor: TSUNG-PEI TSAI, TAINAN CITY (TW)

(21) Appl. No.: 14/690,861

(22) Filed: Apr. 20, 2015

(30) Foreign Application Priority Data
Apr. 25, 2014 (TW) 103115078

(51) Int. Cl. C09K 19/56; C08L 79/08

(52) U.S. Cl. CPC C09K 19/56; C08L 79/08

(57) ABSTRACT

The invention relates to a liquid crystal alignment agent having low ion density, and a liquid crystal alignment film formed thereby and a liquid crystal display element having the liquid crystal alignment film. The liquid crystal alignment agent according to the invention which provides a polymer (A), a benzotriazole compound (B) and a solvent (C); wherein the polymer (A) is obtained by reacting a mixture comprising a tetracarboxylic acid dianhydride component (a) and a diamine component (b).

### BACKGROUND OF THE INVENTION

1. Field of the Invention

The invention relates to a liquid crystal alignment agent and uses thereof. Particularly, the invention relates to a liquid crystal alignment agent having low ion density, and a liquid crystal alignment film formed thereby and a liquid crystal display element having the liquid crystal alignment film.

2. Description of the Related Art

With consumer's increasing requirement of liquid crystal display devices with wide view angles year by year, the requirements of the electrical properties and display properties of liquid crystal display elements with wide view angles have become stricter. Among the liquid crystal display elements with wide view angles, a vertical alignment liquid crystal display element is the most widely applied. For having better electrical and display properties of the vertical alignment liquid crystal display element, a liquid crystal alignment film becomes an important factor.

The liquid crystal alignment film of the vertical alignment liquid crystal display element is mainly used to regularly align liquid crystal molecules, and provides a bigger pretilt angle to the liquid crystal molecules when electrical field is not applied. The aforementioned liquid crystal alignment film is usually formed by coating a liquid crystal alignment agent having a polyamic acid polymer or a polyimide polymer on a surface of a substrate. Then, a thermal treatment and an alignment treatment are performed, thereby obtaining the liquid crystal alignment film.

Patent Cooperation Treaty Patent Publication No. WO2008/117759 discloses a liquid crystal alignment film having high pretilt angle and a diamine compound having a multi-ring side chain for producing the liquid crystal alignment film. The diamine compound having the multi-ring side chain has the structure as shown below:

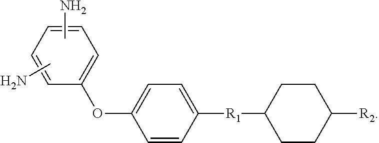

In the aforementioned formula, R₁ represents a phenylene group or a cyclohexylene group; R₂ represents a C₃-C₁₂ alkyl group, a C₃-C₁₂ fluoroalkyl group, a C₃-C₁₂ alkoxy group or a C₃-C₁₂ fluoroalkyl group. The liquid crystal alignment film provides about 88° of pretilt angle, so as to achieve good liquid crystal alignment properties. However, the liquid crystal alignment film has the problem of high ion density, and it cannot be accepted in the field.

Therefore, in order to meet the requirements of the properties of the modern liquid crystal display device, improving ion density is a target remained to be achieved.

### SUMMARY OF THE INVENTION

In the present invention, a specific polymer and a benzotriazole compound are provided to obtain a liquid crystal alignment agent having low ion density.

Therefore, the present invention relates to a liquid crystal alignment agent comprising:
a polymer (A) obtained by reacting a mixture comprising a tetracarboxylic acid dianhydride component (a) and a diamine component (b);
a benzotriazole compound (B); and
a solvent (C);
wherein the benzotriazole compound (B) comprises at least one hydroxyl group;

the diamine component (b) comprises at least one diamine compound (b-1) represented by Formula (I), and an other diamine compound (b-2):

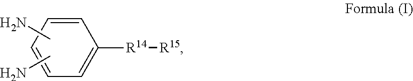

wherein,
R¹⁴ represents

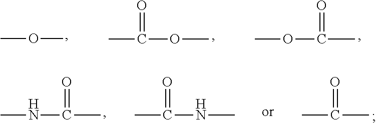

R¹⁵ represents an organic group represented by Formula (I-1);

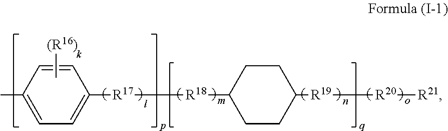

wherein, R¹⁶ represents a hydrogen atom, a fluorine atom or a methyl group;
R¹⁷, R¹⁸ or R¹⁹ each independently represents a single bond,

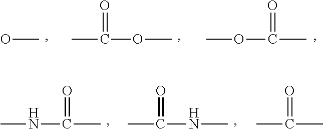

or a C₁-C₃ alkylene group;
R²⁰ represents

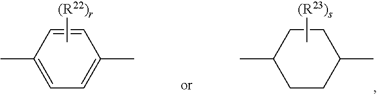

wherein R²² and R²³ each independently represent a hydrogen atom, a fluorine atom or a methyl group; r and s each independently represent 1 or 2; when R²² or R²³ is plural, R²² or R²³ respectively is the same or different;
R²¹ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
k represents 1 or 2;
l, m and n each independently represent an integer from 0 to 4;
o, p and q each independently represent an integer from 0 to 3, and
o+p+q≧3; when R¹⁶, R¹⁷, R¹⁸, R¹⁹ or R²⁰ is plural, R¹⁶, R¹⁷, R¹⁸, R¹⁹ or R²⁰ respectively is the same or different.

The present invention also provides a liquid crystal alignment film made by the liquid crystal alignment agent as mentioned above.

The present invention also provides a method for forming a liquid crystal alignment film comprising coating the liquid crystal alignment agent as mentioned above on a substrate.

The present invention also provides a liquid crystal display element comprising the liquid crystal alignment film as mentioned above.

### BRIEF DESCRIPTION OF THE DRAWINGS

FIG. 1 shows a schematic diagram of a preferred embodiment of a liquid crystal display element according to the invention.

### DETAILED DESCRIPTION OF THE INVENTION

The present invention provides a liquid crystal alignment agent comprising:
a polymer (A) obtained by reacting a mixture comprising a tetracarboxylic acid dianhydride component (a) and a diamine component (b);
a benzotriazole compound (B); and
a solvent (C);
wherein the benzotriazole compound (B) comprises at least one hydroxyl group;
the diamine component (b) comprises at least one diamine compound (b-1) represented by Formula (I), and an other diamine compound (b-2):

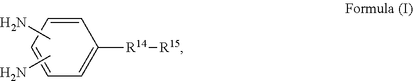

wherein, R¹⁴ represents

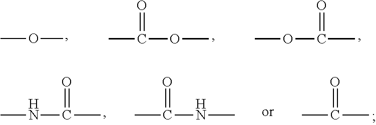

R¹⁵ represents an organic group represented by Formula (I-1);

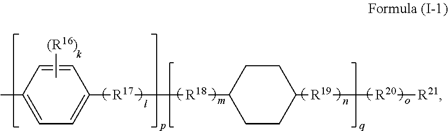

wherein, R¹⁶ represents a hydrogen atom, a fluorine atom or a methyl group;
R¹⁷, R¹⁸ or R¹⁹ each independently represents a single bond,

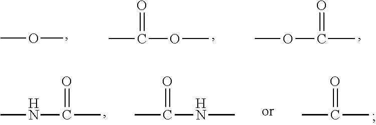

or a C₁-C₃ alkylene group;

R²⁰ represents

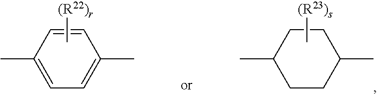

wherein R²² and R²³ each independently represent a hydrogen atom, a fluorine atom or a methyl group; r and s each independently represent 1 or 2; when R²² or R²³ is plural, R²² or R²³ respectively is the same or different;
R²¹ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
k represents 1 or 2;
l, m and n each independently represent an integer from 0 to 4;
o, p and q each independently represent an integer from 0 to 3, and o+p+q≧3; when R¹⁶, R¹⁷, R¹⁸, R¹⁹ or R²⁰ is plural, R¹⁶, R¹⁷, R¹⁸, R¹⁹ or R²⁰ respectively is the same or different.

The polymer (A) according to the invention is obtained by reacting a mixture comprising a tetracarboxylic acid dianhydride component (a) and a diamine component (b).

The tetracarboxylic acid dianhydride component (a) according to the invention refers to a compound comprising at least one tetracarboxylic acid dianhydride compound.

The preferred embodiment of the tetracarboxylic acid dianhydride compound in the tetracarboxylic acid dianhydride component (a) is (1) aliphatic tetracarboxylic acid dianhydride compounds, (2) alicyclic tetracarboxylic acid dianhydride compounds, (3) aromatic tetracarboxylic acid dianhydride compounds, or (4) tetracarboxylic acid dianhydride compounds having the structures of Formulae (II-1) to (II-6). The above mentioned tetracarboxylic acid dianhydride compounds can be used alone or in combinations.

According to the invention, the (1) aliphatic tetracarboxylic acid dianhydride compounds comprise but are not limited to ethane tetracarboxylic dianhydride, or butane tetracarboxylic dianhydride.

According to the invention, the (2) alicyclic tetracarboxylic acid dianhydride compounds comprise but are not limited to 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dicholoro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexyltetracarboxylic dianhydride, cis-3,7-dibutylcycloheptyl-1,5-diene-1,2,5,6-tetracarboxylic dianhydride, 2,3,5-tricarboxyliccycloheptylacetyl dianhydride, or dicyclo[2.2.2]-octyl-7-ene-2,3,5,6-tetracarboxylic dianhydride.

According to the invention, the (3) aromatic tetracarboxylic acid dianhydride compounds comprise but are not limited to 3,4-dicarboxylic-1,2,3,4-tetrahydronaphthalene-1-succinic dianhydride, pyromellitic dianhydride, 3,3′,4,4′-dibenzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′-4,4′-diphenylethane tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furantetracarboxylic dianhydride, 4,4′-bis(3,4-dicarboxylicphenoxyl)phenylene sulfide dianhydride, 4,4′-bis(3,4-dicarboxylicphenoxyl)diphenyl sulfone dianhydride, 4,4′-bis(3,4-dicarboxylicphenoxyl)diphenylpropane dianhydride, 3,3′,4,4′-perfluoroisopropylene diterephthalic acid dianhydride, 3,3′,4,4′-diphenyltetracarboxylic dianhydride, bis(terephthalic acid)phenyl phosphine oxidedianhydride, p-phenylene-bis(triphenylterephthalic acid)dianhydride, m-phenylene-bis(triphenylterephthalic acid)dianhydride, bis(triphenylterephthalic acid)-4,4′-diphenylether dianhydride, bis(triphenylterephthalic acid)-4,4′-diphenylmethane dianhydride, ethylene glycol-bis(anhydrotrimelitate), propylene glycol-bis(anhydrotrimelitate), 1,4-butylene glycol-bis(anhydrotrimelitate), 1,6-heptylene glycol-bis(anhydrotrimelitate), 1,8-octylene glycol-bis(anhydrotrimelitate), 2,2-bis(4-hydrocarbonphenyl)propane-bis(anhydrotrimelitate), 2,3,4,5-tetrahydrofurantetracarboxylic dianhydride, 1,3,3a,4,5,9b-hexahydro-5-(tetrahydro-2,5-dioxofuran-3-yl)naphtho[1,2-c]furan-1,3-dione, 1,3,3a,4,5,9b-hexahydro-5-methyl-5-(tetrahydro-2,5-dioxol-3-furanyl)-naphtho[1,2-c]-furan-1,3-dione, 1,3,3a,4,5,9b-hexahydro-5-ethyl-5-(tetrahydro-2,5-dioxol-3-furanyl)-naphtho[1,2-c]-furan-1,3-dione, 1,3,3a,4,5,9b-hexahydro-7-methyl-5-(tetrahydro-2,5-dioxol-3-furanyl)-naphtho[1,2-c]-furan-1,3-dione, 1,3,3a,4,5,9b-hexahydro-7-ethyl-5-(tetrahydro-2,5-dioxol-3-furanyl)-naphtho[1,2-c]-furan-1,3-dione, 1,3,3a,4,5,9b-hexahydro-8-methyl-5-(tetrahydro-2,5-dioxol-3-furanyl)-naphtho[1,2-c]-furan-1,3-dione, 1,3,3a,4,5,9b-hexahydro-8-ethyl-5-(tetrahydro-2,5-dioxol-3-furanyl)-naphtho[1,2-c]-furan-1,3-dione, 1,3,3a,4,5,9b-hexahydro-5,8-dimethyl-5-(tetrahydro-2,5-dioxol-3-furanyl)-naphtho[1,2-c]-furan-1,3-dione, or 5-(2,5-dioxoltetrahydrofuranyl)-3-methyl-3-cyclohexene-1,2-dicarboxylic acid dianhydride.

According to the invention, the (4) tetracarboxylic acid dianhydride compounds having the structures of Formulae (II-1) to (II-6) are listed below:

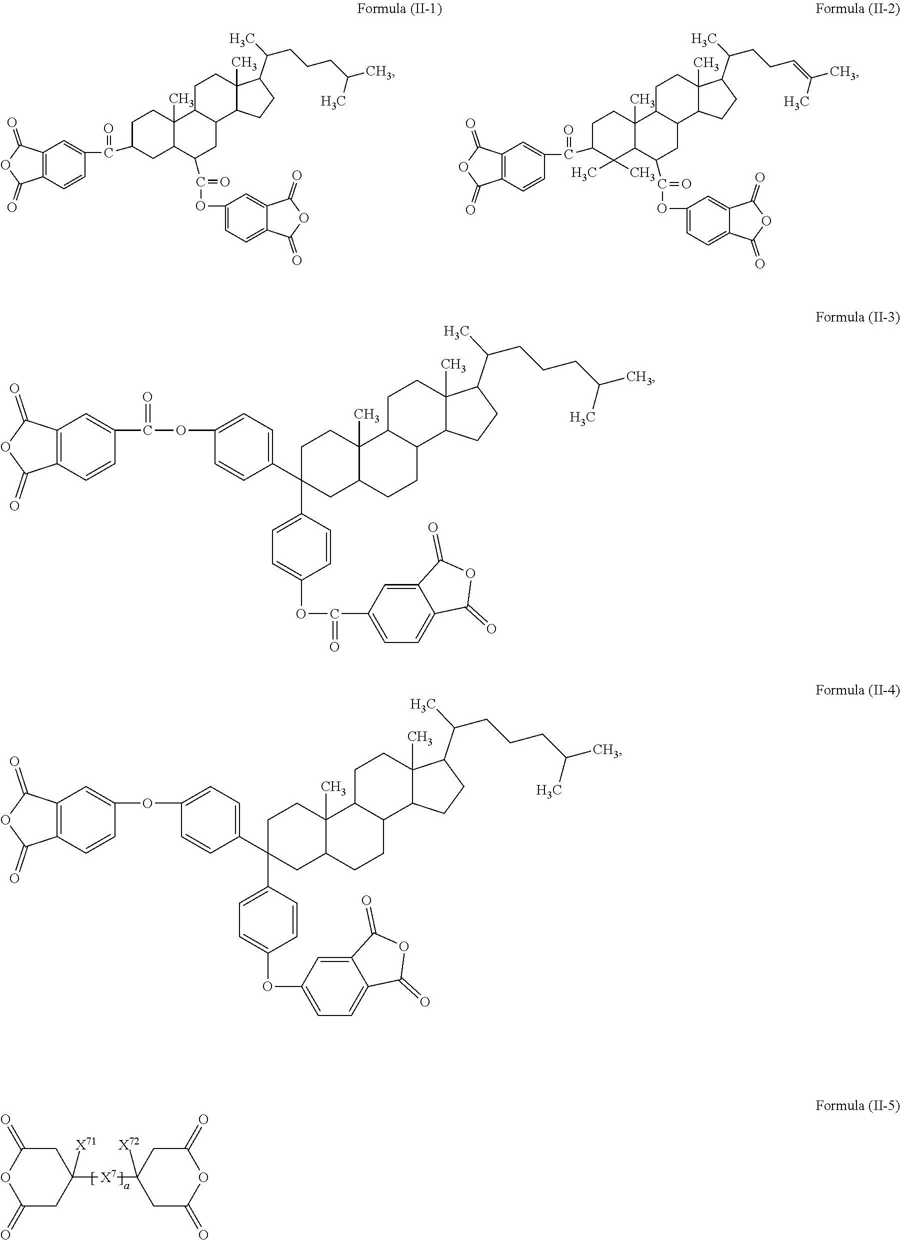

In Formula (II-5), X⁷ represents a divalent group containing an aromatic ring; a represents an integer from 1 to 2; X⁷¹ and X⁷² are the same or different, and each represents a hydrogen atom or an alkyl group. The preferred embodiment of the tetracarboxylic acid dianhydride compounds having the structure of Formula (II-5) is

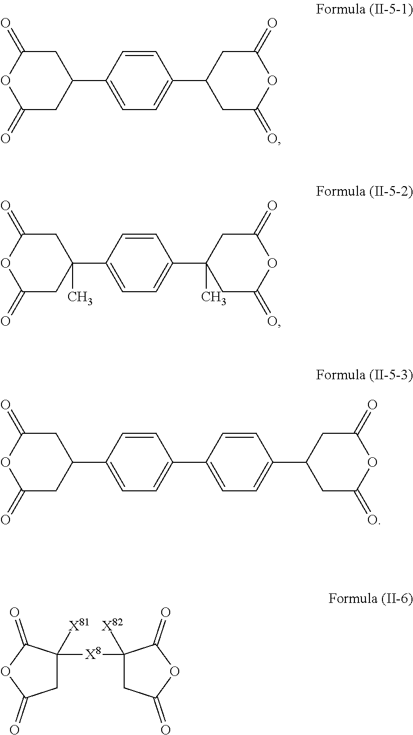

In Formula (II-6), X⁸ represents a divalent group containing an aromatic ring; X⁸¹ and X⁸² are the same or different, and each represents a hydrogen atom or an alkyl group. Preferably, the tetracarboxylic acid dianhydride compounds having the structure of Formula (II-6) is

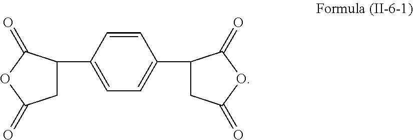 [SMILES: O=C1CC(c2ccc(C3CC(=O)OC3=O)cc2)C(=O)O1]

Preferably, the tetracarboxylic acid dianhydride compounds comprises but is not limited to 1,2,3,4-cyclobutane tetracarboxylic dianhydride, 1,2,3,4-cyclopentane tetracarboxylic dianhydride, 2,3,5-tricarboxyliccycloheptylacetyl dianhydride, 1,2,4,5-cyclohexane tetracarboxylic dianhydride, 3,4-dicarboxylic-1,2,3,4-tetrahydronaphthalene-1-succinicdianhydride, pyromellitic dianhydride, 3,3′,4,4′-dibenzophenonetetracarboxylic dianhydride, or 3,3′,4,4′-biphenylsulfonetetracarboxylic dianhydride.

According to the invention, the diamine component (b) comprises at least one diamine compound (b-1) represented by Formula (I), and an other diamine compound (b-2):

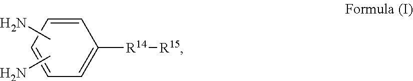

wherein,
R¹⁴ represents

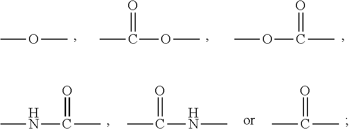

R¹⁵ represents an organic group represented by Formula (I-1);

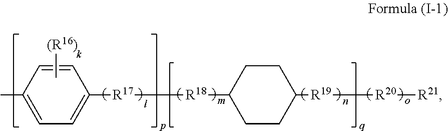

wherein, R¹⁶ represents a hydrogen atom, a fluorine atom or a methyl group;
R¹⁷, R¹⁸ or R¹⁹ each independently represents a single

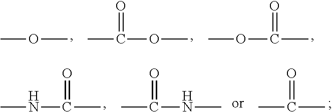

or a C₁-C₃ alkylene group;
R²⁰ represents

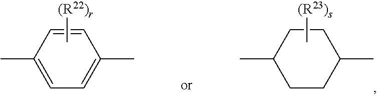

wherein R²² and R²³ each independently represent a hydrogen atom, a fluorine atom or a methyl group; r and s each independently represent 1 or 2; when R²² or R²³ is plural, R²² or R²³ respectively is the same or different;
R²¹ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
k represents 1 or 2;
l, m and n each independently represent an integer from 0 to 4;
o, p and q each independently represent an integer from 0 to 3, and o+p+q≧3; when R¹⁶, R¹⁷, R¹⁸, R¹⁹ or R²⁰ is plural, R¹⁶, R¹⁷, R¹⁸, R¹⁹ or R²⁰ respectively is the same or different.

According to the embodiment of the invention, the diamine compound (b-1) has the structures of Formulae (I-2) to (I-9) listed below:

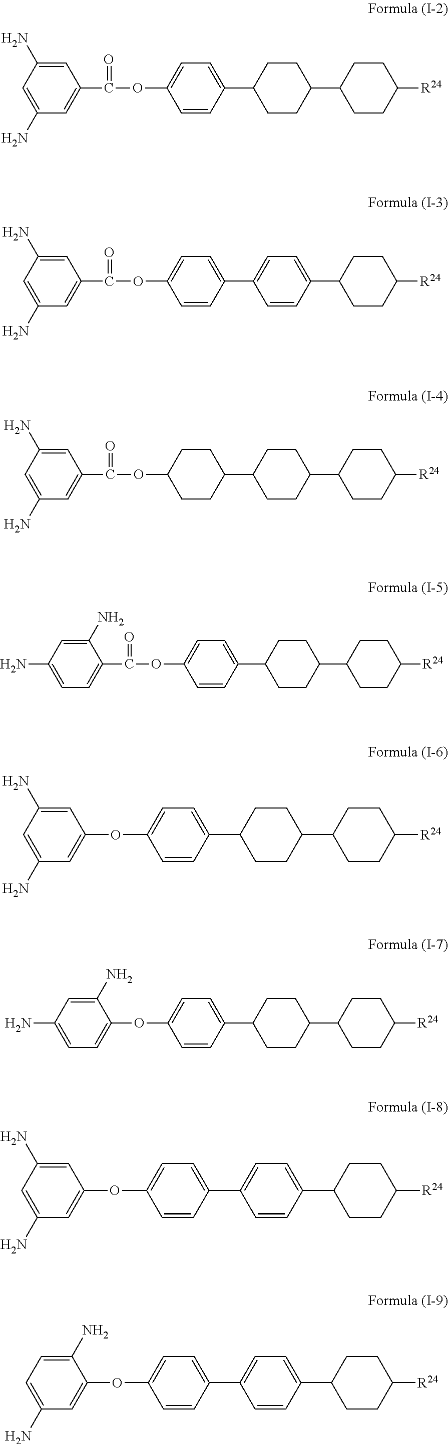

In Formulae (I-2) to (I-9), preferably, R²⁴ represents a hydrogen atom, a C₁-C₁₀ alkyl group or a C₁-C₁₀ alkoxy group.

The diamine compound (b-1) preferably has the structures of Formulae (I-10) to (I-14) listed below:

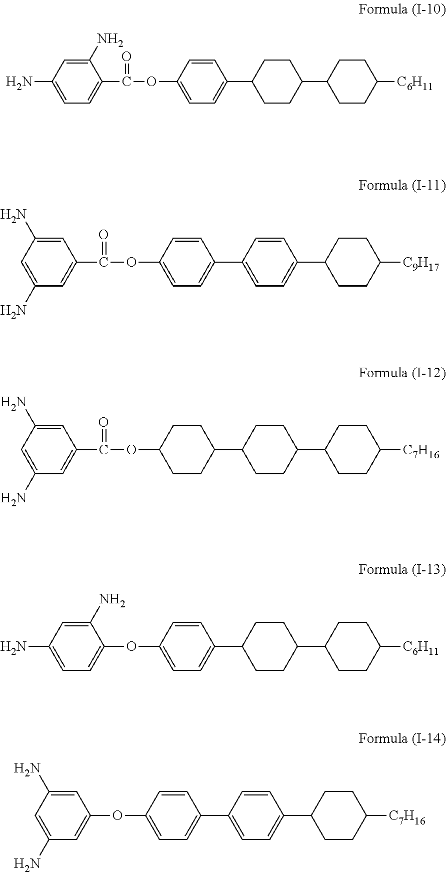

The above mentioned diamine compound (b-1) can be used alone or in combinations.

Based on 100 moles of the used amount of the diamine component (b), the used amount of the diamine compound (b-1) is from 10 to 50 moles; preferably, the used amount of the diamine compound (b-1) is from 15 to 45 moles; more preferably, the used amount of the diamine compound (b-1) is from 20 to 40 moles. If the diamine compound (b-1) is absent, the liquid crystal alignment agent has a defect of poor vertical alignment properties.

The other diamine compound (b-2) includes but is not limited to 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-aminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-di(3-aminopropoxy)ethane, 4,4′-diaminodicyclohexylmethane, 4,4′-diamino-3,3′-dimethyldicyclohexylamine, 1,3-diaminocyclohexane, 1,4-diaminocyclohexane, isophorondiamine, tetrahydrodicyclopentadienediamine, tricyclio(6.2.1.0^{2,7})-undecenedimethylene diamine, 4,4′-methylenedi(cyclohexylamine), 4,4′-diaminodiphenylmethane, 4,4′-diaminodiphenylethane, 4,4′-diaminodiphenylsulfone, 4,4′-diaminobenzoylaniline, 4,4′-diaminodiphenylether, 3,4′-diaminodiphenylether, 1,5-diaminonaphthalene, 5-amino-1-(4′-aminophenyl)-1,3,3-trimethylinden, 6-amino-1-(4′-aminophenyl)-1,3,3-trimethylinden, hexahydro-4,7-methanohydroindenedimethylenediamine, 3,3′-diaminodibenzophenone, 3,4′-diaminodibenzophenone, 4,4′-diamino-dibenzophenone, 2,2-bis[4-(4-aminophenoxyl)phenyl]propane, 2,2-bis[4-(4-aminophenoxyl)phenyl]hexafluoropropane, 2,2-bis(4-aminophenyl)hexafluoropropane, 2,2-bis[4-(4-aminophenoxyl)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisobutenyl)dianiline, 4,4′-(m-phenyleneisobutenyl)dianiline, 2,2′-bis[4-(4-amino-2-trifluoromethylphenoxy)phenyl]hexafluoropropane, 4,4′-bis[(4-amino-2-trifluoromethyl)phenoxy]-octafluorobiphenyl, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane or the other diamine compound (b-2) having the structures of Formulae (III-1) to (III-25) listed below:

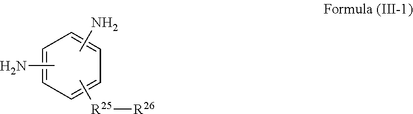

in Formula (III-1),
R²⁵ represents

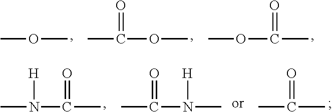

and
R²⁶ represents a steroid group, a trifluoromethyl group, a fluoro group, a C₂-C₃₀ alkyl group or a monovalent group containing a nitrogen atom cyclic structure derived from pyridine, pyrimidine, triazine, piperidine, and piperazine.

Preferably, the other diamine compound (b-2) having the structures of Formula (III-1) is 2,4-diaminophenyl ethyl formate, 3,5-diaminophenyl ethyl formate, 2,4-diaminophenyl propyl formate, 2,4-diaminophenyl propyl formate, 1-dodecoxy-2,4-diaminobenzene, 1-hexadecoxy-2,4-diaminobenzene, 1-octadecoxy-2,4-diaminobenzene or the other diamine compound (b-2) having the structures of Formulae (III-1-1) to (III-1-4) listed below:

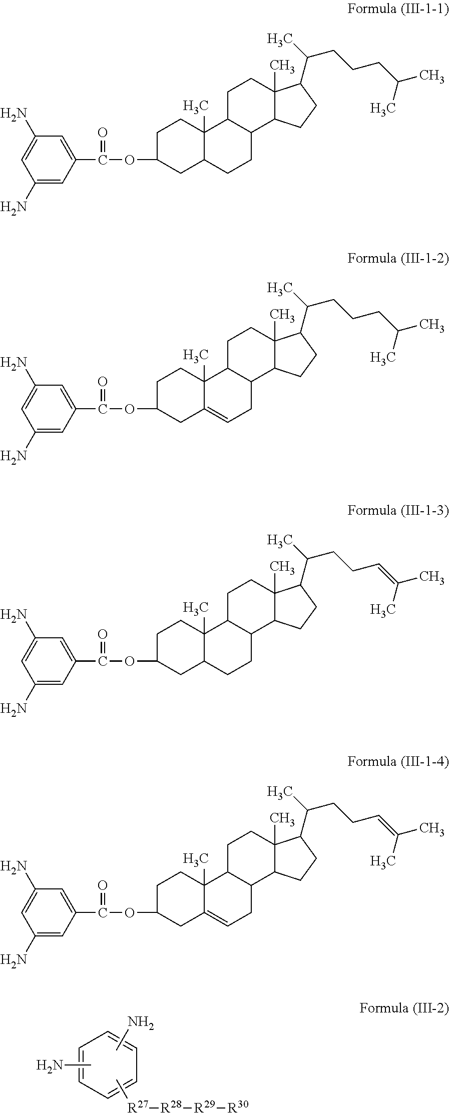

in Formula (III-2),
R²⁷ represents

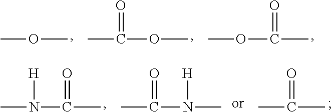

R²⁸ and R²⁹ represent a alicyclic group, an aromatic group, or a heterocyclic group; and
R³⁰ represents a C₃-C₁₈ alkyl group, a C₃-C₁₈ alkoxy group, a C₁-C₅ fluoroalkyl group, a C₁-C₅ fluoroalkoxy group, a cyano group or a halogen atom.

Preferably, the other diamine compound (b-2) has the structures of Formulae (III-2-1) to (III-2-13) listed below:

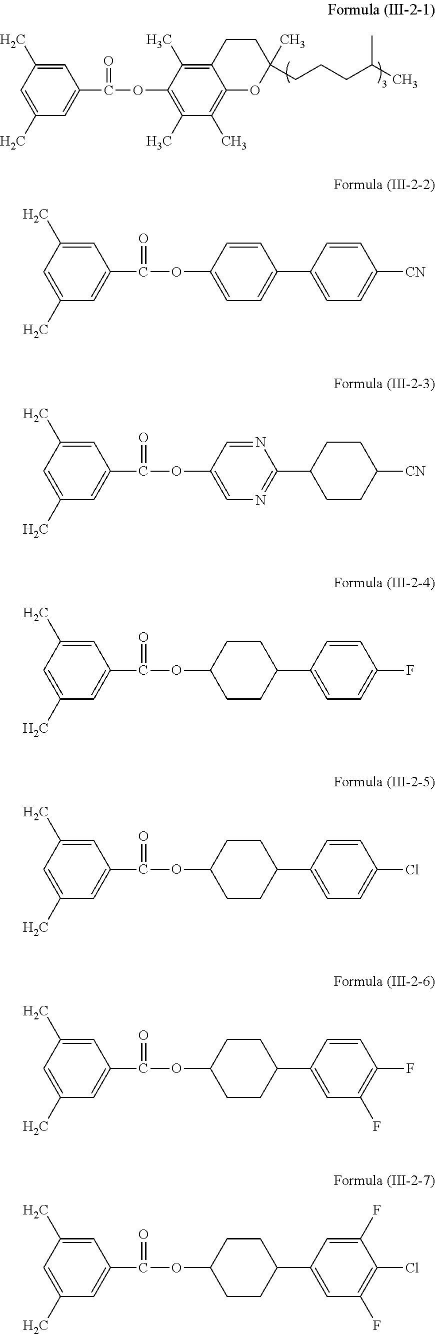

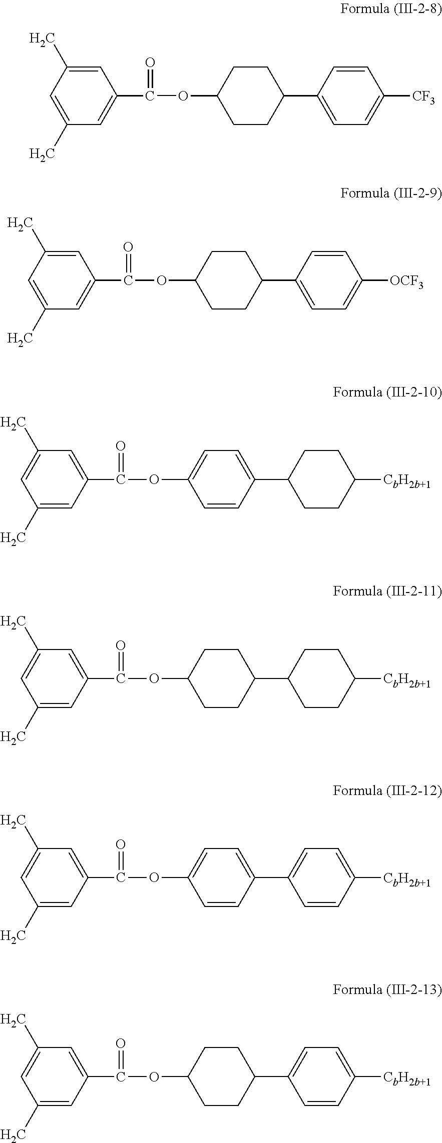

in Formulae (III-2-10) to (III-2-13), b represents an integer from 3 to 12.

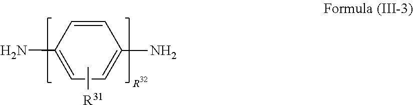

In Formula (III-3), R³¹ represents a hydrogen atom, a C₁-C₅ acyl group, a C₁-C₅ alkyl group, a C₁-C₅ alkoxy group, a halogen atom, and each repeated unit of R³¹ is the same or different; and R³² represents an integer from 1 to 3.

Preferably, the diamine compound having the structure of Formula (III-3) is (1) when R³² is 1: p-diaminebenzene, m-diaminebenzene, o-diaminebenzene or 2,5-diaminotoluene; (2) when R³² is 2: 4,4′-diaminobiphenyl, 2,2′-dimethyl-4,4′-diaminobiphenyl, 3,3′-dimethyl-4,4′-diaminobiphenyl, 3,3′-dimethoxyl-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxylbiphenyl, or 4,4′-diamino-2,2′-di(trifluoromethyl)biphenyl; (3) R³² is 3: 1,4-di(4′-aminophenyl)benzene; more preferably, Formula (III-3) is selected from p-diaminobenzene, 2,5-diaminotoluene, 4,4′-diaminobiphenyl, 3,3′-dimethoxyl-4,4′-diaminobiphenyl, or 1,4-di(4′-aminophenyl)benzene.

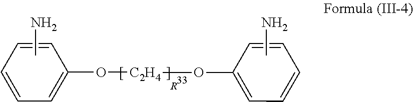

In Formula (III-4), R³³ represents an integer from 2 to 12.

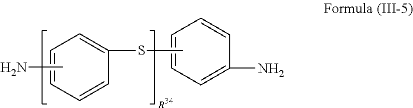

In Formula (III-5), R³⁴ represents an integer from 1 to 5. Preferably, Formula (III-5) is 4,4′-diaminodiphenylsulfide.

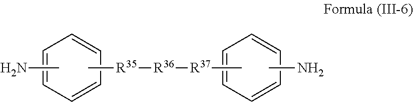

In Formula (III-6), R³⁵ and R³⁷ are the same or different and independently represent a divalent organic group; R³⁶ is a divalent group containing a nitrogen atom cyclic structure derived from pyridine, pyrimidine, triazine, piperidine, and piperazine.

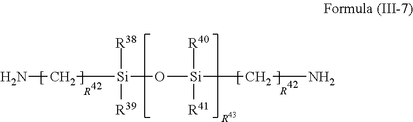

In Formula (III-7), R³⁸, R³⁹, R⁴⁰ and R⁴¹ are the same or different to and represent a C₁-C₁₂ hydrocarbon group. R⁴² represents an integer from 1 to 3; and R⁴³ represents an integer from 1 to 20.

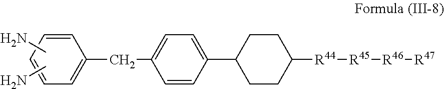

In Formula (III-8), R⁴⁴ represents —O— or a cyclohexalene group; R⁴⁵ represents —CH₂—; R⁴⁶ represents a phenylene group or a cyclohexalene group; and R⁴⁷ represents a hydrogen atom or a heptyl group.

Preferably, the diamine compound having the structure of Formula (III-8) is the diamine compound having the structures of Formulae (III-8-1) to (III-8-2) listed below:

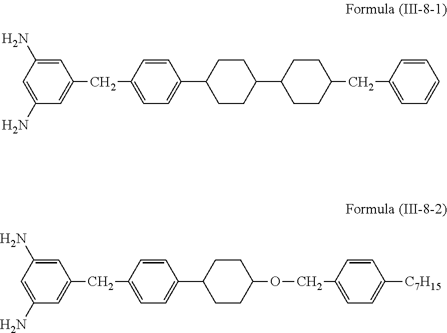

The diamine compound (b-2) having the structure of Formula (III-9) to (III-25) are listed below:

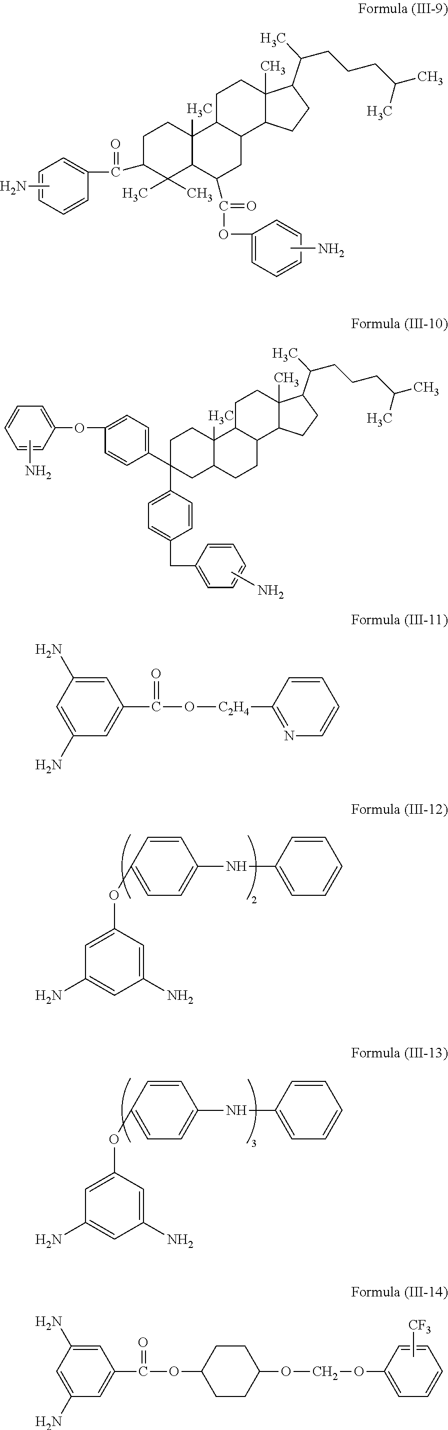

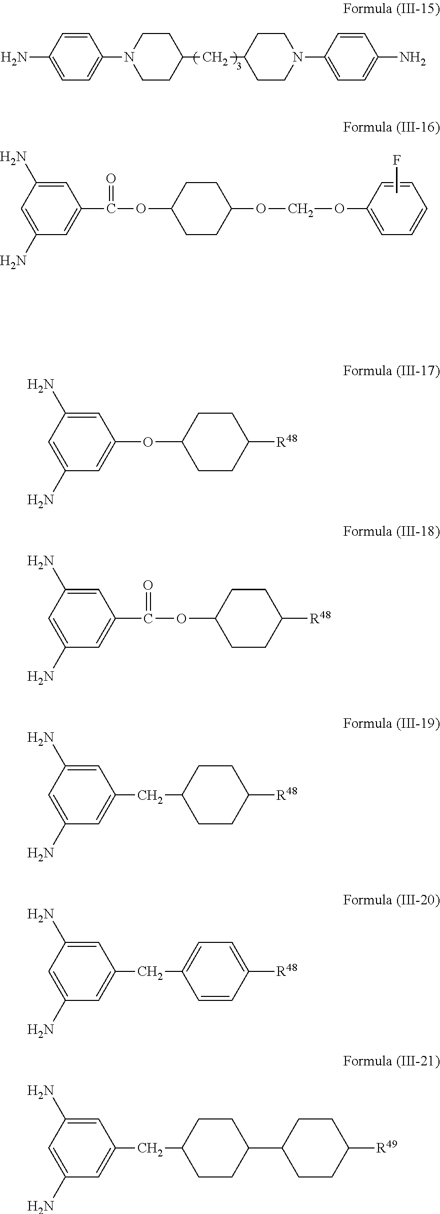

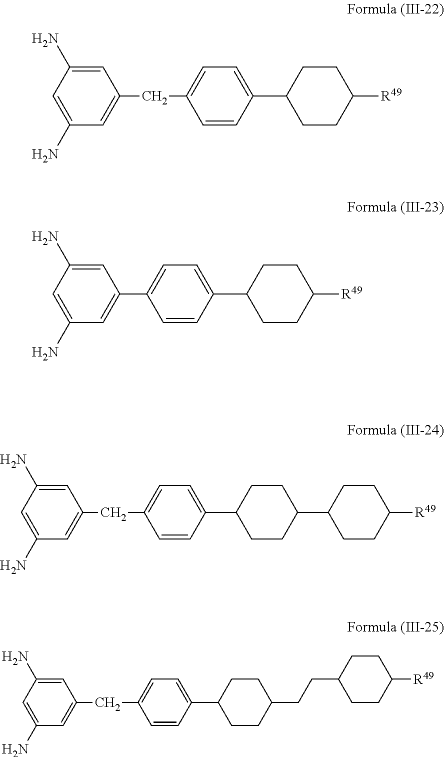

In Formulae (III-17) to (III-25), preferably, R⁴⁸ represents a C₁-C₁₀ alkyl group or a C₁-C₁₀ alkoxy group; preferably, R⁴⁹ represents a hydrogen atom, a C₁-C₁₀ alkyl group or a C₁-C₁₀ alkoxy group.

Preferably, the other diamine compound (b-2) includes but is not limited to 1,2-diaminoethane, 4-4′-diaminodicyclohexylmethane, 4-4′-diaminodiphenylmethane, 4,4′-diaminodiphenylether, 5-[4-(4-n-pentylcyclohexyl)cyclohexyl]phenylmethylene-1,3-diaminebenzene, 1,1-bis[4-(4-aminophenoxyl)phenyl]-4-(4-ethylphenyl)cyclohexane, 2,4-diaminophenylethyl formate, Formula (III-1-1), Formula (III-1-2), Formula (III-2-1), Formula (III-2-11), p-diaminebenzene, m-diaminebenzene, o-diaminebenzene or the compound having the structure of Formula (III-8-1).

Based on 100 moles of the used amount of the diamine component (b), the used amount of the other diamine compound (b-2) is from 1 to 80 moles; preferably, the used amount of the other diamine compound (b-2) is from 10 to 75 moles; more preferably, the used amount of the other diamine compound (b-2) is from 20 to 65 moles.

The preferred embodiment of the polymer (A) is a polyamic acid polymer, a polyimide polymer, a polyimide series block copolymer or combinations thereof. The preferred embodiment of the polyimide series block copolymer is a polyamic acid block copolymer, a polyimide block copolymer, a polyamic acid-polyimide block copolymer or combinations thereof.

The polyamic acid polymer, polyimide polymer and polyimide series block copolymer can all obtained by reacting the tetracarboxylic acid dianhydride component (a) and the diamine component (b).

According to the invention, the preparation of the polyamic acid polymer can be a common one. Preferably, the method for preparing the polyamic acid polymer comprising steps of: dissolving a mixture containing the tetracarboxylic acid dianhydride component (a) and the diamine component (b) in a solvent; conducting a polycondensation at 0° C. to 100° C. for 1 hour to 24 hours; and then distilling the reaction solution under reduced pressure with an evaporator to obtain the polyamic acid polymer; or adding the reaction solution to a large amount of a poor solvent to obtain a precipitate and drying the precipitate by distillation under reduced pressure to obtain the polyamic acid polymer. The solvent used in the polycondensation and the solvent of the liquid crystal alignment agent can be the same or different. The solvent used in the polycondensation is not particularly limited as long as can dissolve the reactants and products. Preferably, the solvent comprises but is not limited to (1) aprotic polar solvent: N-methyl-2-pyrrolidone, N,N-dimethylacetylamine, N,N-dimethylformylamine, dimethylsulfoxide, γ-butyrolactone, tetramethyl urea, or hexamethylphosphoric triamide; (2) phenol solvent: m-cresol, xylenol, phenol, or halogenated phenols. Preferably, the amount of the solvent used in the polycondensation used is 200 parts by weight to 2000 parts by weight based on the 100 parts by weight of the mixture used; more preferably, the amount of the solvent used in the polycondensation used is 300 parts by weight to 1800 parts by weight.

Particularly, in the polycondensation, the solvent can be combined with a proper amount of poor solvent without precipitating the polyamic acid polymer. The poor solvent can be used alone or in combinations, and includes but is not limited to (1) alcohols: methanol, ethanol, isopropanol, cyclohexanol, ethylene glycol, propylene glycol, 1,4-butylene glycol, or triethylene glycol; (2) ketones: acetone, methyl ethyl ketone, methyl isobutyl ketone, or cyclohexanone; (3) esters: methyl acetate, ethyl acetate, butyl acetate, diethyl oxalate, diethyl malonate, or ethylene glycol ethyl ether acetate; (4) ether: diethyl ether, ethylene glycol methyl ether, ethylene glycol ethyl ether, ethylene glycol n-propyl ether, ethylene glycol isopropyl ether, ethylene glycol n-butyl ether, ethylene glycol dimethyl ether, or diethylene ethylene glycol dimethyl ether; (5) halogenated hydrocarbons: dichloromethane, 1,2-dichloroethane, 1,4-dichlorobutane, trichloroethane, chlorobenzene, or o-dichlorobenzene; (6) hydrocarbons: tetrahydrofuran, hexane, heptane, octane, benzene, toluene, or xylene; or (7) combinations thereof. Preferably, the amount of the poor solvent used is from 0 to 60 parts by weight based on 100 parts by weight of the diamine component (a) used; more preferably, the amount of the poor solvent used is from 0 to 50 parts by weight.

According to the invention, the preparation of the polyimide polymer can be a common one, preferably, the preparation of the polyimide polymer comprising dissolving a mixture containing the tetracarboxylic acid dianhydride component (a) and the diamine component (b) in a solvent and conducting a polymerization to form the polyamic acid polymer, and in the presence of a dehydrating agent and catalyst, heating the reactants and conducting a dehydrated ring-closing reaction to change the amide group in the polyamic acid polymer to the imide group in the dehydrated ring-closing reaction and to obtain the polyimide polymer.

Preferably, the imidization ratio of the polymer (A) is usually from 30% to 90%; preferably is from 35% to 85%; more preferably is 40% to 80%. If the imidization ratio is between the ranges, the liquid crystal alignment agent can further decrease the ion density.

The solvent used in the dehydrated ring-closing reaction and the solvent of the liquid crystal alignment agent can be the same and is not repeated herein. Preferably, the amount of the solvent used in the dehydrated ring-closing reaction used is from 200 to 2000 parts by weight based on 100 parts by weight of the polyamic acid polymer used; more preferably, the amount of the solvent used in the dehydrated ring-closing reaction used is from 300 to 1800 parts.

If the reaction temperature of the dehydrated ring-closing reaction is lower than 40° C., the reaction is not completed resulting the degree of the imide of the polyamic acid polymer is poor. However, if the reaction temperature of the dehydrated ring-closing reaction is higher than 200° C., the weight average molecular weight of the polyimide polymer obtained is too low. Therefore, in order to obtain the optimal degree of imide of the polyamic acid polymer, the reaction temperature of the dehydrated ring-closing reaction is preferably 40° C. to 200° C.; more preferably, the reaction temperature of the dehydrated ring-closing reaction is 40° C. to 150° C.

The dehydrating agent used in the dehydrated ring-closing reaction is preferably selected from (1) acid anhydride compounds: acetate anhydride, propionic acid anhydride, or trifluoroacetate anhydride. The amount of the dehydrating agent used is from 0.01 mol to 20 mol based on 1 mol of the polyamic acid polymer used. The catalyst used in the dehydrated ring-closing reaction is selected from (1) pyridines: pyridine, trimethyl pyridine, or dimethyl pyridine; (2)triamines: triethylamine. The amount of the catalyst used is from 0.5 moles to 10 moles based on 1 mol of the dehydrating agent used.

The preferred embodiment of the polyimide series block copolymer is a polyamic acid block copolymer, a polyimide block copolymer, a polyamic acid-polyimide block copolymer or combinations thereof.

According to the invention, the preparation of the polyimide series block copolymer can be a common one. Preferably, the preparation of the polyimide series block copolymer comprising: dissolving a starting agent in a solvent and conducting a polycondensation to obtain the product. The starting agent comprises at least one of the above mentioned polyamic acid polymer and/or at least one of the above mentioned polyimide polymer, and optionally comprises a diamine compound and a tetracarboxylic acid dianhydride compound.

The diamine compound and the tetracarboxylic acid dianhydride compound in the starting agent are the same to the diamine component (a) and the tetracarboxylic acid dianhydride component (b) for preparing the polyamic acid polymer, and the solvent used in the polycondensation is the same to the solvent of the liquid crystal alignment agent and are not repeated herein.

Preferably, the amount of the solvent used in the polycondensation used is from 200 to 2000 parts by weight based on 100 parts by weight of the starting agent used; more preferably, the amount of the solvent used in the polycondensation used is from 300 to 1800 parts. Preferably, the temperature of the polycondensation is 0° C. to 200° C.; more preferably, the temperature of the polycondensation is 0° C. to 100° C.

Preferably, the starting agent includes but is not limited to (1) two polyamic acid polymers with different terminals and structures; (2) two polyimide polymers with different terminals and structures; (3) polyamic acid polymers and polyimide polymers with different terminals and structures; (4) polyamic acid polymers, tetracarboxylic acid dianhydride compounds and diamine compounds, wherein the structures of at least one of the tetracarboxylic acid dianhydride compounds and diamine compounds differ to those of the tetracarboxylic acid dianhydride compound and diamine compound for forming the polyamic acid polymer; (5) polyimide polymers, tetracarboxylic acid dianhydride compounds and diamine compounds, wherein, the structures of at least one of the tetracarboxylic acid dianhydride compounds and diamine compounds differ to those of the tetracarboxylic acid dianhydride compound and diamine compound for forming the polyimide polymer; (6) polyamic acid polymers, polyimide polymers, tetracarboxylic acid dianhydride compounds and diamine compounds, wherein, the structures of the tetracarboxylic acid dianhydride compounds and diamine compounds differ to those of the tetracarboxylic acid dianhydride compound and diamine compound for forming the polyamic acid polymer and polyimide polymer; (7) two polyamic acid polymers, tetracarboxylic acid dianhydride compounds and diamine compounds with different structures; (8) two polyimide polymers, tetracarboxylic acid dianhydride compounds and diamine compounds with different structures; (9) two polyamic acid polymers and diamine compounds with an acid anhydride terminal and with different structures; (10) two polyamic acid polymers and tetracarboxylic dianhydrides with an amino terminal and with different structures; (11) two polyimide polymers and diamines with an acid anhydride terminal and with different structures; (12) two polyimide polymers and tetracarboxylic acid dianhydride compounds with an amino terminal and with different structures.

Without prejudice to the effect of the present invention, preferably, the polyamic acid polymer, the polyimide polymer and the polyimide series block copolymer can be a terminal-modified polymer with molecular weight adjustment. By using the terminal-modified polymer, the coating property of the liquid crystal alignment agent is improved. The preparation of the terminal-modified polymer can be adding a monovalent compound in the polycondensation of the polyamic acid polymer. The monovalent compound comprises but is not limited to (1) monovalent acid anhydrides: maleic anhydride, phthalic anhydride, itaconic anhydride, succinic anhydride, n-decyl, n-dodecyl succinic anhydride, succinic anhydride, n-tetradecyl, or n-hexadecyl succinic anhydride; (2) monovalent amines: aniline, cyclohexylamine, n-butylamine, n-pentyl amine, n-hexylamine, n-heptyl amine, n-octylamine, n-nonyl amine, n-decyl amine, n-undecane amine, n-dodecylamine, n-tridecylamine, n-tetradecyl amine, n-pentadecane amines, amine n-hexadecane, n-heptadecane amine, n-octadecylamine, or n-eicosylamine; (3) monovalent isocyanates: phenyl isocyanate, or naphthyl isocyanate ester.

The benzotriazole compound (B) according to the invention comprises at least one hydroxyl group; preferably the benzotriazole compound (B) comprises at least two hydroxyl groups.

The preferred embodiment of the benzotriazole compound (B) is 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, 2-(2′-hydroxy-3′,5′-di-tert-pentylphenyl)benzotriazole, 2-(2′-hydroxy-3′-(3″,4″,5″,6″-tetrahydrophthalimide methyl)-5′-methyl phenyl)benzotriazole, 2,2-methylenebis {4-(1,1,3,3-tetramethyl butyl)-6-(2H-benzotriazole-2-yl)phenol}, 2-(2′-hydroxy-4′-octylphenyl)benzotriazole, 2-(2,4-dihydroxyphenyl)-2H-benzotriazole, 2-(2,4-dihydroxyphenyl)-5-chloro-2H-benzotriazole, 2-[2′-hydroxy-5′-(2-hydroxyethyl)phenyl]-2H-benzotriazole, 2-[2′-hydroxy-5′-(3-hydroxypropyl)phenyl]-2H-benzotriazole, 2-(2H-benzotriazole-2-yl)-4-(1-hydroxyethyl)phenol, 2H-benzotriazole-2-yl)-4-(1-hydroxy-1-methylethyl)phenol, 2-(2,4-dihydroxyphenyl)-2H-benzotriazole-5-ol, or 2-(2,4,6-trihydroxyphenyl)-2H-benzotriazole-5-ol.

Preferably, the benzotriazole compound (B) includes but is not limited to 2-(2,4-dihydroxyphenyl)-2H-benzotriazole, 2-(2,4-dihydroxyphenyl)-5-chloro-2H-benzotriazole, 2-[2′-hydroxy-5′-(2-hydroxyethyl)phenyl]-2H-benzotriazole, 2-[2′-hydroxy-5′-(3-hydroxypropyl)phenyl]-2H-benzotriazole, 2-(2H-benzotriazole-2-yl)-4-(1-hydroxyethyl)phenol, (2-(2H-benzotriazole-2-yl)-4-(1-hydroxy-1-methylethyl)phenol, 2-(2,4-dihydroxyphenyl)-2H-benzotriazole-5-ol or 2-(2,4,6-trihydroxyphenyl)-2H-benzotriazole-5-ol.

Based on 100 parts by weight of the used amount of the polymer (A), the used amount of the benzotriazole compound (B) is from 0.1 to 5 parts by weight; preferably, the benzotriazole compound (B) is from 0.2 to 4.5 parts by weight; more preferably, the benzotriazole compound (B) is from 0.3 to 4 parts by weight. If the benzotriazole compound (B) is absent, the liquid crystal alignment agent has a defect of high ion density. If the benzotriazole compound (B) comprising at least two hydroxyl groups is used, it can decrease the ion density.

According to the invention, the preferred embodiment of the solvent (C) is N-methyl-2-pyrrolidone, γ-butyrolactone, γ-butyrolactone lactam, 4-hydroxy-4-methyl-2-pentanone, ethylene glycol monomethyl ether, butyl lactate, butyl acetate ester, methoxy methyl propionate, ethyl ethoxy propionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diethylene glycol dimethyl ether, diethylene glycol diethyl ether, diethylene glycol monomethyl ether, diethylene glycol monomethyl ethyl ether, diethylene glycol monomethyl ether acetate, diethylene glycol monoethyl ether acetate, N,N-dimethyl formamide, N,N-dimethyl-acetamide. The solvent can be used alone or in combinations.

In order to achieving the better printing property of the liquid crystal alignment agent, preferably, the amount of the solvent (C) used is from 500 to 3000 parts by weight based on 100 parts by weight of the polymer (A) used; more preferably, the amount of the solvent (C) used is from 800 to 2500 parts by weight; still more preferably, the amount of the solvent (C) used is from 1000 to 2000 parts by weight.

Without prejudice to the effect of the present invention, the liquid crystal alignment agent according to the invention preferably comprises an additive (D). The additive (D) is preferably an epoxy compound or a silane compound having a functional group. The additive (D) is to improve adhesion of the liquid crystal alignment film to the substrate. The additive (D) can be used alone or in combinations.

The silane compound having a functional group includes but is not limited to 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyl dimethoxysilane, 3-ureidopropyltrimethoxysilane, 3-ureidopropyltriethoxy silane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxy silane, N-phenyl-3-aminopropyltriethoxysilane, N-bis(ethyleneoxide)-3-aminopropyltrimethoxysilane, or N-bis(ethyleneoxide)-3-aminopropyltriethoxy silane.

The epoxy compound includes but is not limited to ethylene glycol diglycidyl ether, polyethylene glycol diglycidyl ether, propylene glycol diglycidyl ether, tripropylene glycol diglycidyl ether, polyethylene glycol diglycidyl ether, neopentyl ethylene glycol diglycidyl ether, 1,6-hexanediol diglycidyl ether, glycerin diglycidyl ether, 2,2-dibromo neopentyl glycol diglycidyl ether, 1,3,5,6-tetraglycidyl-2,4-hexanediol, N,N,N′,N′-tetraglycidyl-m-xylene diamine, 1,3-bis(N,N-diglycidylaminomethyl)cyclohexane, N,N,N′,N′-tetraglycidyl-4,4′-diamino diphenyl methane, N,N-glycidyl-p-glycidoxy aniline, 3-(N-allyl-N-glycidyl)aminopropyl trimethoxy silane, or 3-(N,N-diglycidyl)aminopropyl trimethoxy silane.

The preparation of the liquid crystal alignment agent is not particularly limited, and can be a common mixture method; such as mixing the polyamic acid polymer and the polyimide polymer and optionally the polyimide series block copolymer to form the polymer (A), and then adding the benzotriazole compound (B) and the solvent (C) to the polymer (A) at 0° C. to 200° C. and optionally adding the additive (D) and mixing with a stirring means to dissolving the reactants. Preferably, at 20° C. to 60°, adding the benzotriazole compound (B) and the solvent (C) to the polymer composition.

Preferably, the amount of the additive (D) used is from 0.5 to 50 parts by weight based on 100 parts by weight of the polymer (A) used; more preferably, the amount of the additive used is from 1 to 45 parts by weight.

The present invention also provides a liquid crystal alignment film made by the liquid crystal alignment agent as mentioned above.

The present invention also provides a method for forming a liquid crystal alignment film comprising coating the liquid crystal alignment agent as mentioned above on a substrate.

Preferably, the method for forming the liquid crystal alignment film comprising: coating the liquid crystal alignment agent on a surface of a substrate to form a coating film by a roller coating method, a spinner coating method, a printing method, or an inkjet method; and conducting a pre-bake treatment, post-bake treatment and alignment treatment to obtain the coating film.

The pre-bake treatment is for volatilizing the organic solvent in the coating film. Preferably, the pre-bake treatment is conducted at 30° C. to 120° C.; more preferably at 40° C. to 110° C.; still more preferably at 50° C. to 100° C.

The alignment treatment is not limited, and can be conducted by rubbing in a certain direction for alignment with a roller wound with a cloth made by nylon, rayon, cotton and other fibers.

The post-bake treatment is for a further dehydrated ring-closing reaction (imidization) of the polymer in the coating film. Preferably, the post-back treatment is conducted at 150° C. to 300° C., more preferably at 180° C. to 280° C., still more preferably at 200° C. to 250° C.

The present invention also provides a liquid crystal display element comprising the liquid crystal alignment film as mentioned above.

The method for producing the liquid crystal display element is known to artisans skilled in this field and only briefed as below.

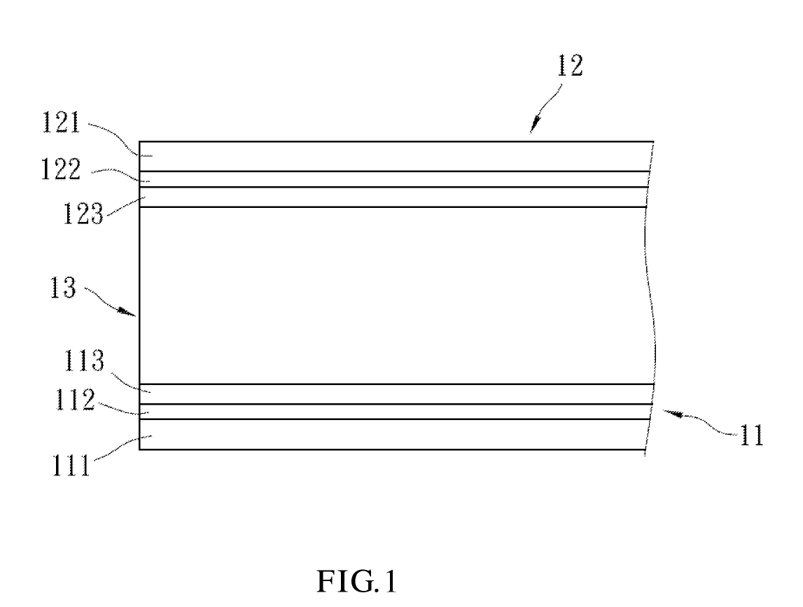

Referring to FIG. 1, in the preferred embodiment of the invention, the liquid crystal display element comprises a first unit 11, a second unit 12 set opposite to the first unit 11 with an interval, and a liquid crystal unit 13 set between the first unit 11 and the second unit 12.

The first unit 11 comprises a first substrate 111, a first conductive film 112 formed on the first substrate 111, and a first liquid crystal alignment film 113 formed on a surface of the first conductive film 112.

The second unit 12 comprises a second substrate 121, a second conductive film 122 formed on the second substrate 121, and a second liquid crystal alignment film 123 formed on a surface of the second conductive film 122.

The first substrate 111 and the second substrate 121 are a transparent material. The transparent material includes but is not limited to alkali-free glass, soda-lime glass, hard glass (Pyrex glass), and quartz glass, polyethylene terephthalate, polybutylene terephthalate, polyether sulfone, or polycarbonate for liquid crystal display device. The material of the first conductive film 112 and the second conductive film 122 is selected from SnO₂, In₂O₃—SnO₂, or the like.

The first liquid crystal alignment film 113 and the second liquid crystal alignment film 123 are the above mentioned liquid crystal alignment film, respectively, and are for forming a pretilt angle of the liquid crystal unit 13. The liquid crystal unit 13 can be driven by the electric field formed by the first conductive film 112 and the second conductive film 122.

The liquid crystal used in the liquid crystal unit 13 can be used alone or in combinations. The liquid crystal includes but is not limited to diaminobenzene liquid crystal, pyridazine liquid crystal, shiff base liquid crystal, azoxy liquid crystal, biphenyl liquid crystal, phenyl cyclohexane liquid crystal, ester liquid crystal, terphenyl liquid crystal, biphenylcyclohexane liquid crystal, pyrimidine liquid crystal, dioxane liquid crystal, bicyclooctane liquid crystal, or cubane liquid crystal, and optionally adding steroid liquid crystal such as cholesteryl chloride, cholesteryl nonanoate, or cholesteryl carbonate), or chiral agent such as C-15, CB-15 (manufactured by Merck), or ferroelectric liquid crystal such as p-decyloxybenzylidene-p-amino-2-methylbutyl cinnamate.

The following examples are given for the purpose of illustration only and are not intended to limit the scope of the present invention.

### Preparation of the Polymer (A)

### Synthesis Example A-1-1

A 500 mL four-necked flask set with a nitrogen inlet, stirrer, condenser and thermometer, and nitrogen was purged. The feed composition comprising 2.77 g (0.006 mol) of a compound having the structure of Formula (I-10) (hereafter referred as b-1-1), 4.75 g (0.044 mol) of p-diaminobenzene and 80 g of N-methyl-2-pyrrolidone (hereafter referred as NMP) was stirred to dissolve. Then, 9.8 g (0.05 mol) of 1,2,3,4-cyclobutane tetracarboxylic dianhydride (hereafter referred as a-1) and 20 g of NMP were added for reacting at the room temperature for 2 hours. After completing the reaction, the reaction solution was poured into 1500 mL of water to precipitate the polymers. The polymers filtered were washed with methanol and filtered for three times and dried at 60° C. with a vacuum oven to obtain the polyamic acid polymer (A-1-1).

### Synthesis Examples A-1-2 to A-1-3 and Comparative Synthesis Example A-3-1

The Synthesis Examples A-1-2 to A-1-3 and Comparative Synthesis Example A-3-1 are similar to Synthesis Example A-1-1 with the modifications of various kinds and amounts of the compositions for the polymer composition. The formulations and evaluation results thereof are listed in Table 1 and Table 2 and are not repeated herein.

### Synthesis Example A-2-1

A 500 mL four-necked flask set with a nitrogen inlet, stirrer, condenser and thermometer, and nitrogen was purged. The feed composition comprising 2.77 g (0.006 mol) of b-1-1, 4.75 g (0.044 mol) of p-diaminobenzene and 80 g of NMP was stirred to dissolve. Then, 9.8 g (0.05 mol) of 1,2,3,4-cyclobutane tetracarboxylic dianhydride and 20 g of NMP were added for reacting at the room temperature for 6 hours, then 97 g NMP, 2.55 g acetic oxide and 19.75 g pyridine were added, the temperature was raised to 60° C. and the composition was stirred for 2 hours. After completing the reaction, the reaction solution was poured into 1500 mL of water to precipitate the polymers. The polymers filtered were washed with methanol and filtered for three times and dried at 60° C. with a vacuum oven to obtain the polyamic acid polymer (A-2-1).

### Synthesis Examples A-2-2 to A-2-8 and Comparative Synthesis Example A-3-2 to A-3-4

The Synthesis Examples A-2-2 to A-2-8 and Comparative Synthesis Example A-3-2 to A-3-4 are similar to Synthesis Example A-2-1 with the modifications of various kinds and amounts of the compositions for the polymer composition. The formulations and evaluation results thereof are listed in Table 1 and Table 2 and are not repeated herein.

TABLE 1

| | | Synthesis Examples | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Component (mole %) | | A-1-1 | A-1-2 | A-1-3 | A-2-1 | A-2-2 | A-2-3 | A-2-4 | A-2-5 | A-2-6 | A-2-7 | A-2-8 |
| tetracarboxylic | a-1 | 100 | | | 100 | | | | 100 | 90 | | |
| acid dianhydride | a-2 | | 100 | | | 100 | | 50 | | 10 | 60 | 100 |
| component (a) | a-3 | | | 100 | | | 100 | 50 | | | 40 | |
| diamine | b-1-1 | 12 | | | 12 | | | 10 | | | | 25 |
| component | b-1-2 | | 15 | | | 15 | | | | 25 | 20 | 25 |
| (b) | b-1-3 | | | 20 | | | 20 | | 40 | | 10 | |
| | b-2-1 | 88 | | | 88 | | | 60 | 50 | | | |
| | b-2-2 | | 70 | | | 70 | | 30 | | 55 | | 50 |
| | b-2-3 | | 15 | 75 | | 15 | 75 | | | 20 | 70 | |
| | b-2-4 | | | 5 | | | 5 | | 10 | | | |
| | b-2-5 | | | | | | | | | | | |

| | | | | | | | | | | | |
|---|---|---|---|---|---|---|---|---|---|---|---|
| imidization ratio (%) | 0 | 0 | 0 | 12 | 23 | 30 | 50 | 64 | 78 | 90 | 93 |

TABLE 2

| | | Comparative Synthesis Examples | | | |
|---|---|---|---|---|---|
| | | 1 | 2 | 3 | 4 |
| Component (mole %) | | A-3-1 | A-3-2 | A-3-3 | A-3-4 |
| tetracarboxylic | a-1 | 100 | | | |
| acid dianhydride | a-2 | | 100 | | |
| component (a) | a-3 | | | 100 | 100 |
| diamine | b-1-1 | | | | |
| component | b-1-2 | | | | |
| (b) | b-1-3 | | | | |
| | b-2-1 | 88 | | 20 | |
| | b-2-2 | 12 | 70 | | 55 |
| | b-2-3 | | 30 | 75 | 20 |
| | b-2-4 | | | 5 | |
| | b-2-5 | | | | 25 |

| | | | | |
|---|---|---|---|---|
| imidization ratio (%) | 0 | 23 | 30 | 78 |

### In Table 1 and Table 2:

a-1 1,2,3,4-cyclobutane tetracarboxylic dianhydride
a-2 pyromellitic dianhydride
a-3 2,3,5-tricarboxycyclopentylacetic acid dianhydride
b-1-1 Formula (I-10)
b-1-2 Formula (I-12)
b-1-3 Formula (I-14)
b-2-1 p-diaminebenzene
b-2-2 4,4′-diaminodiphenylmethane
b-2-3 1-octadecoxy-2,4-diaminobenzene
b-2-4 Formula (III-1-2)
b-2-5 Formula (III-2-10), b=5

### Preparation of Liquid Crystal Alignment Agent, Liquid Crystal Alignment Film and Liquid Crystal Display Element

### Example 1

One-hundred parts by weight of the polymer (A) prepared as Synthesis Example A-1-1, 0.3 parts by weight of 2-(2′-hydroxy-5′-tert-butylphenyl)benzotriazole, 1200 parts by weight of NMP and 600 parts by weight of ethylene glycol n-butyl ether were mixed at the room temperature to form a liquid crystal alignment agent.

The liquid crystal alignment agent was coated on two glass substrates with ITO (indium-tin-oxide) conductive film by a printing machine (manufactured by Japan Nissha Printing Co., Ltd., Model No. S15-036) to form coating films. The coating films were heated at 100° C. by a heating plate for 5 minutes for a pre-bake treatment and then heated at 220° C. by a circulation oven for 30 minutes for a post-bake treatment. After an alignment treatment, a liquid crystal alignment film was obtained on each of the glass substrates.

One of the two glass substrates having the liquid crystal alignment film as mentioned above was coated with thermal-compression adhesive agent, and the other was poured with spacers of 4 μm. The two glass substrates were adhered at 150° C. in the vertical direction of alignment and pressed by 10 kg with a heat pressing machine. Then, liquid crystal was added by a liquid crystal pouring machine (manufactured by Shimadzu Corporation, Model No. ALIS-100X-CH), and the injection port of liquid crystal was sealed with UV curing adhesive and cured by UV irradiation. An annealing treatment was conducted at 60° C. for 30 minutes in an oven to obtain a liquid crystal display element. The liquid crystal alignment agent and liquid crystal display element were evaluated as below and the results are shown in Table 2.

### Examples 2 to 12 and Comparative Examples 1 to 6

Examples 2 to 12 and Comparative Examples 1 to 6 are similar to Example 1 for the preparation of the liquid crystal alignment agent, liquid crystal alignment film and liquid crystal display element with the modifications of the kind and amount of the polymer composition, solvent, and additive shown in Table 3. The liquid crystal alignment agent and liquid crystal display element are evaluated as below and the results are shown in Table 3.

### Comparative Examples 7

One-hundred parts by weight of the polymer (A) prepared as Synthesis Example A-1-1, 0.3 parts by weight of 2,4-dihydroxybenzophenone, 1200 parts by weight of NMP and 600 parts by weight of ethylene glycol n-butyl ether were mixed at the room temperature to form a liquid crystal alignment agent.

### Comparative Examples 8

One-hundred parts by weight of the polymer (A) prepared as Synthesis Example A-1-1, 0.3 parts by weight of benzotriazole, 1200 parts by weight of NMP and 600 parts by weight of ethylene glycol n-butyl ether were mixed at the room temperature to form a liquid crystal alignment agent.

TABLE 3

| Component | | Example | | | | | | | | | |
|---|---|---|---|---|---|---|---|---|---|---|---|
| (parts by weight) | | 1 | 2 | 3 | 4 | 5 | 6 | 7 | 8 | 9 | 10 |
| polymer | A-1-1 | 100 | | | | | | | | | |
| (A) | A-1-2 | | 100 | | | | | | | | |
| | A-1-3 | | | 100 | | | | | | | |
| | A-2-1 | | | | 100 | | | | | | |
| | A-2-2 | | | | | 100 | | | | | |
| | A-2-3 | | | | | | 100 | | | | |
| | A-2-4 | | | | | | | 100 | | | |
| | A-2-5 | | | | | | | | 100 | | |
| | A-2-6 | | | | | | | | | 100 | |
| | A-2-7 | | | | | | | | | | 100 |
| | A-2-8 | | | | | | | | | | |
| | A-3-1 | | | | | | | | | | |
| | A-3-2 | | | | | | | | | | |
| | A-3-3 | | | | | | | | | | |
| | A-3-4 | | | | | | | | | | |
| benzotriazole | B-1 | 0.3 | | | | 1 | | | | | 0.8 |
| compound | B-2 | | 0.1 | | | 1 | 1 | | 0.5 | 2 | |
| (B) | B-3 | | | 1.5 | | | | 3 | | | |
| | B-4 | | | | 5 | | | | | 2 | |
| solvent | C-1 | 1200 | | 800 | | | 1000 | 900 | 850 | 1400 | |
| (C) | C-2 | 600 | 1600 | | 800 | 1500 | | 300 | 850 | | 1000 |
| | C-3 | | | 1000 | 800 | 100 | 600 | 300 | | | 800 |
| Assay | vertical | ◯ | ◯ | ◯ | ◯ | ◯ | ◯ | ◯ | ◯ | ◯ | ◯ |
| | alignment | | | | | | | | | | |
| | property | | | | | | | | | | |
| | ion density | ◯ | ◯ | ⊚ | ⊚ | ◯ | ⊚ | ⊚ | ⊚ | ⊚ | ⊚ |

| Component | | Example | | Comparative Example | | | | | |
|---|---|---|---|---|---|---|---|---|---|
| (parts by weight) | | 11 | 12 | 1 | 2 | 3 | 4 | 5 | 6 |
| polymer | A-1-1 | | | | 100 | | | | |
| (A) | A-1-2 | | | | | | | | |
| | A-1-3 | | 50 | | | | | | |
| | A-2-1 | | | | | | | | |
| | A-2-2 | | | | | | | | |
| | A-2-3 | | | | | | | | |
| | A-2-4 | | | | | | | | |
| | A-2-5 | | | | | | | | |
| | A-2-6 | | 50 | | | | 100 | | |
| | A-2-7 | | | | | | | | |
| | A-2-8 | 100 | | | | | | | |
| | A-3-1 | | | 100 | | | | | |
| | A-3-2 | | | | | 100 | | | |
| | A-3-3 | | | | | | | 100 | |
| | A-3-4 | | | | | | | | 100 |
| benzotriazole | B-1 | | | 0.3 | | | | | |
| compound | B-2 | 0.1 | 0.2 | | | | | 0.1 | |
| (B) | B-3 | 0.2 | | | | | | | |
| | B-4 | | | | | | | | |
| solvent | C-1 | 1500 | | 1200 | 1200 | | 1400 | | |
| (C) | C-2 | | 1000 | 600 | 600 | 800 | | 1600 | |
| | C-3 | | 350 | | | 800 | | | |
| Assay | vertical | ◯ | ◯ | X | ◯ | X | ◯ | X | X |
| | alignment | | | | | | | | |
| | property | | | | | | | | |
| | ion density | ⊚ | ⊚ | X | X | X | X | X | X |

B-1 2-(2′-hydroxy-5′-tert-butylphenyl)benzotriazole
B-2 2-(2′-hydroxy-3′,5′-di-tert-butylphenyl)benzotriazole
B-3 2-(2,4-dihydroxyphenyl)-2H-benzotriazole
B-4 2-(2,4,6-trihydroxyphenyl)-2H-benzotriazole-5-ol
C-1 N-methyl-2-pyrrolidone
C-2 ethylene glycol n-butyl ether
C-3 N,N-dimethylacetylamine

### <Evaluation Items>

a. Imidization Ratio (%):

The imidization ratio refers to a ratio of the number of imide ring in the total amount of the number of amic acid functional group and the number of imide ring, and the imidization ratio is presented by percentage.

After reduced pressure drying the polymer (A) of Synthesis Examples A-1-1 to A-1-3, A-2-1 to A-2-8 and Comparative Synthesis Examples A-3-1 to A-3-3, respectively, the polymer (A) was dissolved in a suitable deuteration solvent, such as dimethyl sulfoxide. ¹H-NMR (hydrogen-nuclear magnetic resonance) was detected at the room temperature (25° C.) using tetramethylsilane as a standard, and the imidization ratio (%) was calculated according to the following formula:

$$Imidization Ratio ( \% ) = [ 1 - \frac{Δ1}{Δ2 \times a} ] \times 100 \%$$

In the aforementioned formula, Δ1 is the peak area of the chemical shift induced by the proton of NH group near 10 ppm, Δ2 is the peak area of other proton, and a is the ratio of one proton of NH group corresponding to the number of other proton in the polyamic acid precursor.

b. Vertical Alignment Property:

The vertical alignment property was measured by observing the liquid crystal display element under a polarized optical microscope without applied voltage and applied alternating voltage 8V (peak-to-peak) from vertical direction. The evaluation standards are as follows.
◯: no leakage light
x: poor white display occurrence
   c. Ion Density:

The ion density of the liquid crystal display element in Examples 1 to 12 and Comparative Example 1 to 6 was measured by an electrical measuring machine (manufactured by TOYO Corporation, Model 6254) with the condition of applying 1.7 Volt, 0.01 Hz of triangular wave. In the current-voltage waveform, the ion density was determined by calculating the peak area of 0 to 1 volt. The evaluation standards are as follows.
⊚: ion density<20
◯: 20≦ion density<40
Δ: 40≦ion density<50
x: ion density≧50

In Comparative Example 7 and 8, the result of the vertical alignment property are all ◯; however, the result of the ion density are all x.

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A liquid crystal alignment agent comprising:
a polymer (A) obtained by reacting a mixture comprising a tetracarboxylic acid dianhydride component (a) and a diamine component (b);
a benzotriazole compound (B); and
a solvent (C);
wherein the benzotriazole compound (B) comprises at least one hydroxyl group;
the diamine component (b) comprises at least one diamine compound (b-1) represented by Formula (I), and an other diamine compound (b-2): 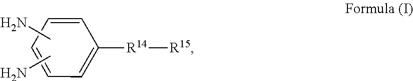
wherein,
R¹⁴ represents 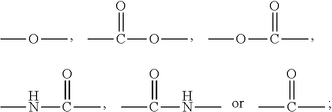
R¹⁵ represents an organic group represented by Formula (I-1); 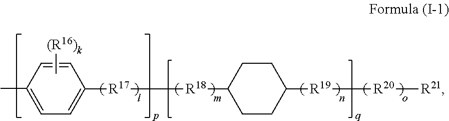
wherein, R¹⁶ represents a hydrogen atom, a fluorine atom or a methyl group;
R¹⁷, R¹⁸ or R¹⁹ each independently represents a single bond, 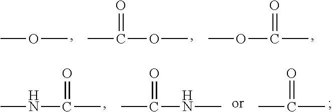
or a C₁-C₃ alkylene group;
R²⁰ represents 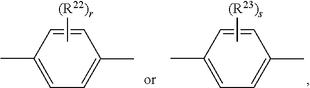
wherein R²² and R²³ each independently represent a hydrogen atom, a fluorine atom or a methyl group; r and s each independently represent 1 or 2; when R²² or R²³ is plural, R²² or R²³ respectively is the same or different;
R²¹ represents a hydrogen atom, a fluorine atom, a C₁-C₁₂ alkyl group, a C₁-C₁₂ fluoroalkyl group, a C₁-C₁₂ alkoxy group, — OCH₂F, —OCHF₂ or —OCF₃;
k represents 1 or 2;
l, m and n each independently represent an integer from 0 to 4;
o, p and q each independently represent an integer from 0 to 3, and o+p+q≧3; when R¹⁶, R¹⁷, R¹⁸, R¹⁹ or R²⁰ is plural, R¹⁶, R¹⁷, R¹⁸, R¹⁹ or R²⁰ respectively is the same or different.

2. The liquid crystal alignment agent according to claim 1, wherein the benzotriazole compound (B) comprises at least two hydroxyl groups.

3. The liquid crystal alignment agent according to claim 1, wherein based on 100 parts by weight of the used amount of the polymer (A), the used amount of the benzotriazole compound (B) is from 0.1 to 5 parts by weight.

4. The liquid crystal alignment agent according to claim 1, wherein based on 100 moles of the used amount of the diamine component (b), the used amount of the diamine compound (b-1) is from 10 to 50 moles.

5. The liquid crystal alignment agent according to claim 1, wherein the imidization ratio of the polymer (A) ranges from 30% to 90%.

6. A liquid crystal alignment film made by the liquid crystal alignment agent according to claim 1.

7. A method for forming a liquid crystal alignment film comprising coating the liquid crystal alignment agent according to claim 1 on a substrate.

8. A liquid crystal display element comprising the liquid crystal alignment film according to claim 6.
